(19) United States
(12) Patent Application Publication
(10) Pub. No.: US 2005/0025882 A1
(43) Pub. Date: Feb. 3, 2005

(54) Optical elements with protective undercoating

(76) Inventors: William N. Partlo, Poway, CA (US); Daniel J.W. Brown, San Diego, CA (US); Tom A. Yager, Encinitas, CA (US); Weiman Zhang, San Diego, CA (US)

Correspondence Address: CYMER INC;LEGAL DEPARTMENT, 17075 Thornmint Court, SAN DIEGO, CA, 92127-2413, US

(21) Appl. No.: 10/872,620

(22) Filed: Jun. 21, 2004

Related U.S. Application Data
(63) Continuation-in-part of application No. 10/384,967, filed on Mar. 8, 2003.
Application No. 10/384,967 is a continuation-in-part of application No. 10/233,253, filed on Aug. 30, 2002, now Pat. No. 6,704,339.
Application No. 10/233,253 is a continuation-in-part of application No. 10/141,216, filed on May 7, 2002, now Pat. No. 6,693,939.
Application No. 10/141,216 is a continuation-in-part of application No. 10/036,676, filed on Dec. 21, 2001.
Application No. 10/036,676 is a continuation-in-part of application No. 10/036,727, filed on Dec. 21, 2001.
Application No. 10/036,727 is a continuation-in-part of application No. 10/006,913, filed on Nov. 29, 2001, now Pat. No. 6,535,531.
Application No. 10/006,913 is a continuation-in-part of application No. 10/000,991, filed on Nov. 14, 2001, now Pat. No. 6,795,474.
Application No. 10/000,991 is a continuation-in-part of application No. 09/943,343, filed on Aug. 29, 2001, now Pat. No. 6,567,450.
Application No. 09/943,343 is a continuation-in-part of application No. 09/829,475, filed on Apr. 9, 2001, now Pat. No. 6,765,945.
Application No. 09/829,475 is a continuation-in-part of application No. 09/771,789, filed on Jan. 29, 2001, now Pat. No. 6,539,042.

(51) Int. Cl. B05D 5/06; B32B 9/00

(52) U.S. Cl. 427/162; 428/696

(57) ABSTRACT

An apparatus and method are disclosed for an optical element which may comprise a main optical body comprising a crystal containing halogen atoms; a reflectivity coating for changing the reflectivity of a surface of the main body; and, an intermediate protective layer comprising a material containing free halogen atoms. The crystal may comprise an alkaline earth metal and may comprise fluorine atoms, e.g., calcium fluoride or magnesium fluoride. The intermediate protective layer may comprises a material containing free fluorine atoms, e.g., a material doped with fluorine atoms, e.g., doped fused silica. The intermediate layer comprises an amorphous portion and a polycrystalline portion. The optical element may also comprise a main optical element body; a reflectivity coating comprising a metal halide on an exterior the a surface of the main optical body; and a thin layer of protective outer coating on the reflectivity coating comprising a dense non-porous material thin enough to be transparent to the light of a selected short wavelength. The reflectivity coating may comprise a plurality of layers with at least one layer comprising a metal fluoride and the protective outer coating may comprise a layer of silicon oxyfluoride.

### RELATED APPLICATIONS

The present application is a continuation-in-part of United States Published Patent Application No. 2003/0219056A1, with inventors Yager et al., entitled HIGH POWER DEEP ULTRAVIOLET LASER WITH LONG LIFE OPTICS, published on Nov. 27, 2003, based upon an application Ser. No. 10/384,967, filed on Mar. 8, 2003, Attorney Docket No. 2003-0005-02, which was based on Provisional Applications Ser. No. 60/442,579, entitled HIGH POWER DEEP ULTRAVIOLET LASER WITH LONG LIFE OPTICS, filed on Jan. 24, 2003, and Ser. No. 60/445,715 filed Feb. 7, 2003, entitled AUTO SHUTTER MODULE FOR GAS DISCHARGE LASER, and Ser. No. 60/443,673 filed Jan. 28, 2003, entitled LITHOGRAPHY LASER WITH BEAM DELIVERY AND BEAM POINTING CONTROL, and Ser. No. 60/426,888, entitled HIGH POWER DEEP ULTRAVIOLET LASER WITH LONG LIFE OPTICS, filed Nov. 15, 2002, and Ser. No. 60/412,349, ENTITLED HIGH POWER DEEP ULTRAVIOLET LASER WITH LONG LIFE OPTICS, filed Sep. 20, 2002, each of which is assigned to the assignee of the present application the disclosures of which are incorporated herein by reference.

### FIELD OF THE INVENTION

The present invention relates to optical elements that are exposed to high amounts of fluence and/or high total optical power over time, e.g., in uses in high power, high repetition rate gas discharge laser DUV and EUV light sources, e.g., for use in illumination for integrated circuit lithography.

### BACKGROUND OF THE INVENTION

It is known in the art of high power, high repetition rate, narrow banded and short pulse duration gas discharge laser, e.g., excimer or molecular fluorine lasers, e.g., operating in the DUV or shorter wavelengths, e.g., below about 250 nm, that optical damage to the optical elements seeing the highest fluence levels, is a serious problem to efficient operation, including interference with various beam quality parameters that need to be maintained and ultimate failure and need for replacement. CaF₂ optics have been conventionally thought to be robust enough to withstand such fluences and wavelengths. Applicants in the above referenced Published Application proved that to not be the case and proposed the solution disclosed and claimed therein. Applicants have discovered another utilization for silicon oxyfluoride as disclosed and claimed in the present application. Applicants have discovered that for high power, high repetition rate, narrow banded and short pulse duration gas discharge lasers, e.g., excimer or molecular fluorine lasers, e.g., operating in the DUV or shorter wavelengths, and especially at 193 nm for ArF excimer lasers, damage is occurring to optical coatings, e.g., multi-layer stacks of reflective coating, e.g., containing several tens of layers and/or anti-reflective coatings of only, e.g., two layers. These coatings are used e.g., with CaF₂ optical element subtrates, e.g., for optical elements in an ArF excimer gas discharge laser, e.g., used as a light source for photolithography, with all of the power and pulse repetition rate and duty cycle demands on the endurance of optical elements well known in that art. The present invention provides a solution to this problem.

### SUMMARY OF THE INVENTION

An apparatus and method are disclosed for an optical element which may comprise a main optical body comprising a crystal containing halogen atoms; a reflectivity coating for changing the reflectivity of a surface of the main body; and, an intermediate protective layer comprising a material containing free halogen atoms. The crystal may comprise an alkaline earth metal and may comprise fluorine atoms, e.g., calcium fluoride or magnesium fluoride. The intermediate protective layer may comprises a material containing free fluorine atoms, e.g., a material doped with fluorine atoms, e.g., doped fused silica. The intermediate layer comprises an amorphous portion and a polycrystalline portion. The optical element may also comprise a main optical element body; a reflectivity coating comprising a metal halide on an exterior the a surface of the main optical body; and a thin layer of protective outer coating on the reflectivity coating comprising a dense non-porous material thin enough to be transparent to the light of a selected short wavelength. The reflectivity coating may comprise a plurality of layres coating with at least one layer comprising a metal fluoride and the protective outer coating may comprise a layer of silicon oxyfluoride.

### BRIEF DESCRIPTION OF THE DRAWINGS

FIG. 1 shows an optical element having a reflectivity coating;

FIG. 2 shows a optical element with a reflective coating on one side and an anti-reflective coating on the other side and a protective intermediate layer according to aspects of an embodiment of the present invention; and

FIG. 3 shows aspects of an embodiment of the present invention.

### DETAILED DESCRIPTION OF PREFERRED EMBODIMENTS

The damage having been observed by applicants to the optical coatings at, e.g., 193 nm wavelengths of optical fluence is attributed by applicants to multiple photon absorption in the substrate optical element containing fluorine. This is believed to cause fluorine atoms to be dislodged from the crystalline structure of the CaF₂ accumulate at the substrate reflective coating boundary and even diffuse somewhat into the lower most layer(s) of the multi-layer stack forming the reflective coating, which contains layers comprising a metal fluoride.

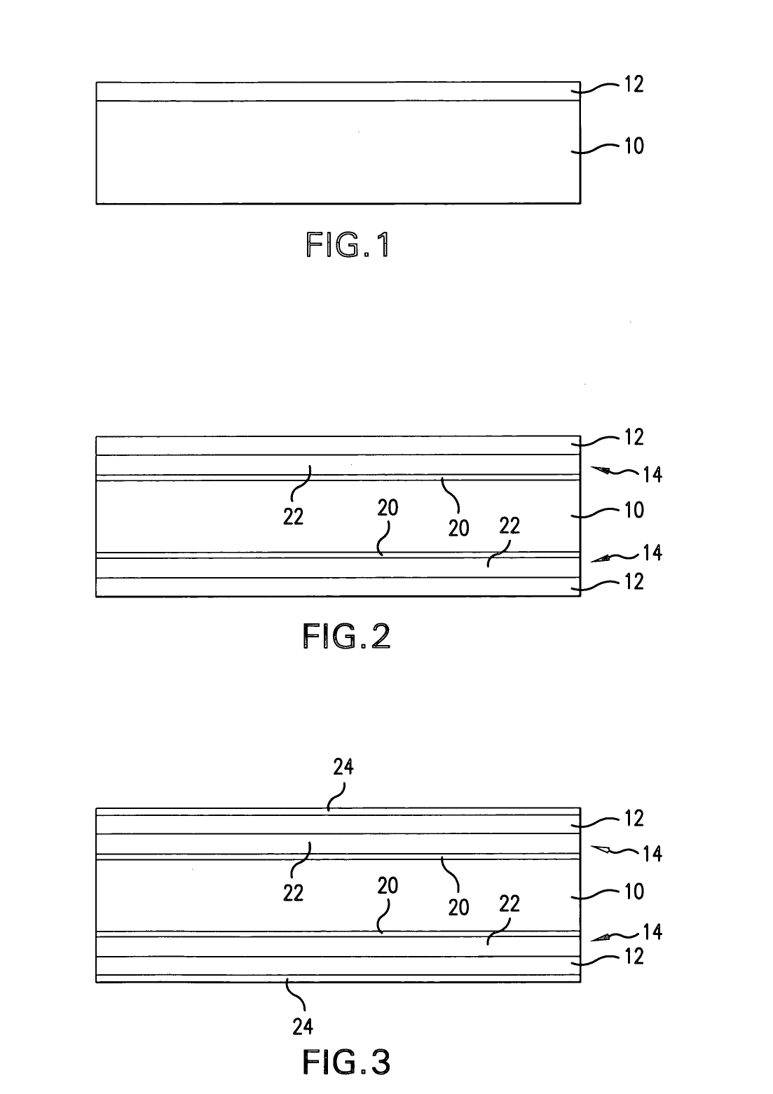

FIG. 1 is an illustration of a optical element substrate 10 with a multi-layer stack 12 containing layers of a metal fluoride, e.g., thirty two layers, forming a reflective coating. Applicants have been observing explosive pitting in the multi-layer stack reflective coating and have theorized that the fluorine accumulation, not shown, at the substrate 10 boundary with the multi-layer reflective coating 12 weakens the multi-layer stack reflective coating and eventually when a fluorine atom in the boundary region absorbs a photon an explosive eruption occurs through the entire multi-layer stack forming a pit, and eventually enough of these cause optical and/or physical failure of the multi-layer stack reflective coating. This can also occur in anti-reflective coatings where the stack is only two layers thick.

Applicants have tested and shown that a layer of silicon oxyfluoride SiOₓF_{y}, where the x and y denote the stoichiometry of the oxygen and fluorine respectively, i.e., the atomic ratios of the O and F to the Si, also known as fluorine doped fused silica, intermediate the substrate 10. The silicon oxyfluoride may be formed of two layers of the same material deposited in different ways, e.g., a relatively thin layer 20, e.g., about 5 nm of amorphous material, deposited, e.g., with an e-beam evaportation deposition process, while fluorine is being introduced as a dopant, e.g., in about 0.5% (by weight), and a second more dense and polycrystalline layer, also with fluorine dopant in about 0.5% by weight, deposited, e.g., with an ion assisted e-beam evaporation deposition process. The ion assist results in a much more densely packed portion 22 of the fluorine doped fused silica layer 14, e.g., with a high packing ratio of approximately 1.0.

The amorphous portion 20 of layer 14 is relatively softer and more malleable than the denser portion 22 of the layer 14 of fluorine doped fused silica and therefore forms a cushioning interface between the crystal of the substrate 10 and the relatively stiff polycrystalline portion 22 of the fluorine doped fused silica layer 14.

Applicants theorize that, just as the presence of fluorine atoms at the surface of an optical element protects the optical element, e.g., a CaF₂ with fluorine in its crystal structure, from damage, e.g., at 193 nm in a ArF laser system, as noted in the above reference co-pending patent application s assigned to applicants' common assignee, so the presence of the fluorine atoms in the layer 14 diffuses fluorine back into the crystal surface to replace fluorine atoms dislodged by photons, or alternatively at least provides a relatively stress-free accumulation boundary layer between the substrate 10 and the multi-layer stack reflective coating 12 so that the dislodged fluorine atoms cannot reach the multi-layer reflective coating 12 inner boundary, or a combination of the two. It is also possible that the mechanism is entirely something else, but applicants have found that the silicon oxyfluoride coating does work to prevent enough of the occurrences such that the silicon oxyfluoride coated CaF₂ can survive over the billions of pulses of light required to be transmitted through the types of optics noted above in the types of UV laser light sources noted above.

It will be understood by those skilled the art that the aspects of embodiments of the present invention have been described as illustrative only and that many variations and modifications t can be made by those skilled in the art based upon the teaching of the present application and that the inventions described in the appended claims should not be considered to be limited to the aspects of the preferred embodiments described in this patent application. For example, other fluorine or halide containing crystals, e.g., other alkaline earth metal (Group2) halogen crystals, e.g., MgF₂, may be utilized for the substrate. Other crystalline substances may be used as well. Additionally other non-crystalline intermediate layers possessing free fluorine atoms may be utilized besides silicon oxyfluoride. The precise thicknesses, content of fluorine atoms, type of deposition process and the like may also be modified without departing from the spirit and intent and scope of the appended claims. The coating may be, as noted above, a reflective or an anti-reflective coating, and the generic term reflectivity coating should be understood to encompass both, of which many are known and need not necessarily contain fluorine but could contain, e.g., some other halogen.

Turning now to FIG. 3 three is shown aspects of an embodiment of the present invention wherein, e.g., a high density silicon-oxyfluoride coating 24 is used to protect the metal fluoride reflectivity coatings 12. As shown in FIG. 3, e.g., a thin film of dense polycrystalline silicon oxyfluoride is placed on the exterior of the metal fluoride layers 12. The outer silicon oxyfluoride layers may be deposited as noted above and may be thin enough to be essentially invisible or transparent to the appropriate wavelength, e.g., 5-20 nm at a 193 nm light wavelength. This hard glassy dense polycrystalline silicon oxyfluoride layer can serve to protect the underlying reflectivity coatings from damage, e.g., due to environmental conditions, e.g., from moisture, oxygen or other contaminants in the environment of the optical element 10.

It will be understood that many changes and modification can be made to the present invention without changing the spirit and intent of the appended claims and that the claims are not limited to the specific aspects of embodiments of the invention disclosed in this application.

1. An optical element comprising:
a main optical body comprising a crystal containing halogen atoms;
a reflectivity coating for changing the reflectivity of a surface of the main body; and,
an intermediate protective layer comprising a material containing free halogen atoms.

2. The apparatus of claim 1 further comprising:
the crystal comprises an alkaline earth metal.

3. The apparatus of claim 1 further comprising:
the crystal comprises fluorine atoms.

4. The apparatus of claim 1 further comprising:
the crystal comprises calcium fluoride.

5. The apparatus of claim 2 further comprising:
the crystal comprises calcium fluoride.

6. The apparatus of claim 3 further comprising:
the crystal comprises calcium fluoride.

7. The apparatus of claim 1 further comprising:
the crystal comprises magnesium fluoride.

8. The apparatus of claim 2 further comprising:
the crystal comprises magnesium fluoride.

9. The apparatus of claim 3 further comprising:
the crystal comprises magnesium fluoride.

10. The apparatus of claim 1 further comprising:
the intermediate protective layer comprises a material containing free fluorine atoms.

11. The apparatus of claim 2 further comprising:
the intermediate protective layer comprises a material containing free fluorine atoms.

12. The apparatus of claim 3 further comprising:
the intermediate protective layer comprises a material containing free fluorine atoms.

13. The apparatus of claim 4 further comprising:
the intermediate protective layer comprises a material containing free fluorine atoms.

14. The apparatus of claim 5 further comprising:
the intermediate protective layer comprises a material containing free fluorine atoms.

15. The apparatus of claim 6 further comprising:
the intermediate protective layer comprises a material containing free fluorine atoms.

16. The apparatus of claim 7 further comprising:
the intermediate protective layer comprises a material containing free fluorine atoms.

17. The apparatus of claim 8 further comprising:
the intermediate protective layer comprises a material containing free fluorine atoms.

18. The apparatus of claim 9 further comprising:
the intermediate protective layer comprises a material containing free fluorine atoms.

19. The apparatus of claim 10 further comprising:
the intermediate protective layer comprises a material doped with fluorine atoms.

20. The apparatus of claim 11 further comprising:
the intermediate protective layer comprises a material doped with fluorine atoms.

21. The apparatus of claim 12 further comprising:
the intermediate protective layer comprises a material doped with fluorine atoms.

22. The apparatus of claim 13 further comprising:
the intermediate protective layer comprises a material doped with fluorine atoms.

23. The apparatus of claim 14 further comprising:
the intermediate protective layer comprises a material doped with fluorine atoms.

24. The apparatus of claim 15 further comprising:
the intermediate protective layer comprises a material doped with fluorine atoms.

25. The apparatus of claim 16 further comprising:
the intermediate protective layer comprises a material doped with fluorine atoms.

26. The apparatus of claim 17 further comprising:
the intermediate protective layer comprises a material doped with fluorine atoms.

27. The apparatus of claim 18 further comprising:
the intermediate protective layer comprises a material doped with fluorine atoms.

28. The apparatus of claim 19 further comprising:
the intermediate protective layer comprises doped fused silica.

29. The apparatus of claim 20 further comprising:
the intermediate protective layer comprises doped fused silica.

30. The apparatus of claim 21 further comprising:
the intermediate protective layer comprises doped fused silica.

31. The apparatus of claim 22 further comprising:
the intermediate protective layer comprises doped fused silica.

32. The apparatus of claim 23 further comprising:
the intermediate protective layer comprises doped fused silica.

33. The apparatus of claim 24 further comprising:
the intermediate protective layer comprises doped fused silica.

34. The apparatus of claim 25 further comprising:
the intermediate protective layer comprises doped fused silica.

35. The apparatus of claim 26 further comprising:
the intermediate protective layer comprises doped fused silica.

36. The apparatus of claim 37 further comprising:
the intermediate protective layer comprises doped fused silica.

37. The apparatus of claim 1 further comprising:
the intermediate layer comprises an amorphous portion and a polycrystalline portion.

38. The apparatus of claim 2 further comprising:
the intermediate layer comprises an amorphous portion and a polycrystalline portion.

39. The apparatus of claim 3 further comprising:
the intermediate layer comprises an amorphous portion and a polycrystalline portion.

40. The apparatus of claim 4 further comprising:
the intermediate layer comprises an amorphous portion and a polycrystalline portion.

41. The apparatus of claim 5 further comprising:
the intermediate layer comprises an amorphous portion and a polycrystalline portion.

42. The apparatus of claim 6 further comprising:
the intermediate layer comprises an amorphous portion and a polycrystalline portion.

43. The apparatus of claim 7 further comprising:
the intermediate layer comprises an amorphous portion and a polycrystalline portion.

44. The apparatus of claim 8 further comprising:
the intermediate layer comprises an amorphous portion and a polycrystalline portion.

45. The apparatus of claim 9 further comprising:
the intermediate layer comprises an amorphous portion and a polycrystalline portion.

46. A method of forming an optical element comprising:
providing a main optical body comprising a crystal containing halogen atoms;
applying a reflectivity coating for changing the reflectivity of a surface of the main body; and,
applying an intermediate protective layer comprising a material containing free halogen atoms.

47. The method of claim 46 further comprising:
the crystal comprises an alkaline earth metal.

48. The method of claim 46 further comprising:
the crystal comprises fluorine atoms.

49. The method of claim 46 further comprising:
the crystal comprises calcium fluoride.

50. The method of claim 47 further comprising:
the crystal comprises calcium fluoride.

51. The method of claim 48 further comprising:
the crystal comprises calcium fluoride.

52. The method of claim 46 further comprising:
the crystal comprises magnesium fluoride.

53. The method of claim 47 further comprising:
the crystal comprises magnesium fluoride.

54. The method of claim 48 further comprising:
the crystal comprises magnesium fluoride.

55. The method of claim 49 further comprising:
the intermediate protective layer comprises a material containing free fluorine atoms.

56. The method of claim 50 further comprising:
the intermediate protective layer comprises a material containing free fluorine atoms.

57. The method of claim 51 further comprising:
the intermediate protective layer comprises a material containing free fluorine atoms.

58. The method of claim 52 further comprising:
the intermediate protective layer comprises a material containing free fluorine atoms.

59. The method of claim 50 further comprising:
the intermediate protective layer comprises a material containing free fluorine atoms.

60. The method of claim 51 further comprising:
the intermediate protective layer comprises a material containing free fluorine atoms.

61. The method of claim 52 further comprising:
the intermediate protective layer comprises a material containing free fluorine atoms.

62. The method of claim 53 further comprising:
the intermediate protective layer comprises a material containing free fluorine atoms.

63. The method of claim 54 further comprising:
the intermediate protective layer comprises a material containing free fluorine atoms.

64. The method of claim 55 further comprising:
the intermediate protective layer comprises a material doped with fluorine atoms.

65. The method of claim 56 further comprising:
the intermediate protective layer comprises a material doped with fluorine atoms.

66. The method of claim 57 further comprising:
the intermediate protective layer comprises a material doped with fluorine atoms.

67. The method of claim 58 further comprising:
the intermediate protective layer comprises a material doped with fluorine atoms.

68. The method of claim 59 further comprising:
the intermediate protective layer comprises a material doped with fluorine atoms.

69. The method of claim 60 further comprising:
the intermediate protective layer comprises a material doped with fluorine atoms.

70. The method of claim 61 further comprising:
the intermediate protective layer comprises a material doped with fluorine atoms.

71. The method of claim 62 further comprising:
the intermediate protective layer comprises a material doped with fluorine atoms.

72. The method of claim 63 further comprising:
the intermediate protective layer comprises a material doped with fluorine atoms.

73. The method of claim 64 further comprising:
the intermediate protective layer comprises doped fused silica.

74. The method of claim 65 further comprising:
the intermediate protective layer comprises doped fused silica.

75. The method of claim 66 further comprising:
the intermediate protective layer comprises doped fused silica.

76. The method of claim 67 further comprising:
the intermediate protective layer comprises doped fused silica.

77. The method of claim 68 further comprising:
the intermediate protective layer comprises doped fused silica.

78. The method of claim 69 further comprising:
the intermediate protective layer comprises doped fused silica.

79. The method of claim 70 further comprising:
the intermediate protective layer comprises doped fused silica.

80. The method of claim 71 further comprising:
the intermediate protective layer comprises doped fused silica.

81. The method of claim 72 further comprising:
the intermediate protective layer comprises doped fused silica.

82. The method of claim 46 further comprising:
the intermediate layer comprises an amorphous portion and a polycrystalline portion.

83. The method of claim 47 further comprising:
the intermediate layer comprises an amorphous portion and a polycrystalline portion.

84. The method of claim 48 further comprising:
the intermediate layer comprises an amorphous portion and a polycrystalline portion.

85. The method of claim 49 further comprising:
the intermediate layer comprises an amorphous portion and a polycrystalline portion.

86. The method of claim 50 further comprising:
the intermediate layer comprises an amorphous portion and a polycrystalline portion.

87. The method of claim 51 further comprising:
the intermediate layer comprises an amorphous portion and a polycrystalline portion.

88. The method of claim 52 further comprising:
the intermediate layer comprises an amorphous portion and a polycrystalline portion.

89. The method of claim 53 further comprising:
the intermediate layer comprises an amorphous portion and a polycrystalline portion.

90. The method of claim 54 further comprising:
the intermediate layer comprises an amorphous portion and a polycrystalline portion.

92. An optical element comprising:
a main optical element body;
a reflectivity coating comprising a metal halide on an exterior surface of the main optical body;
a thin layer of protective outer coating on the reflectivity coating comprising a dense non-porous material thin enough to be transparent to the light of a selected short wavelength.

93. The apparatus of claim 92 further comprising:
the reflectivity coating comprises a plurality of layers with at least one layer comprising a metal fluoride.

94. The apparatus of claim 92 further comprising:
the protective outer coating comprises a layer of silicon oxyfluoride.

95. The apparatus of claim 93 further comprising:
the protective outer coating comprises a layer of silicon oxyfluoride.

95. A method of protecting an optical element comprising:
providing a main optical element body;
coating an exterior surface of the main optical element body with a reflectivity coating comprising a metal halide;
coating an exterior surface of the reflectivity coating with a thin layer of protective outer coating comprising a dense non-porous material thin enough to be transparent to the light of a selected short wavelength.

96. The method of claim 95 further comprising:
the reflectivity coating comprises a plurality of layers with at least one layer comprising a metal fluoride.

97. The method of claim 95 further comprising:
the protective outer coating comprises a layer of silicon oxyfluoride.

98. The method of claim 96 further comprising:
the protective outer coating comprises a layer of silicon oxyfluoride.
